(19) United States
(12) Patent Application Publication
(10) Pub. No.: US 2021/0049268 A1
(43) Pub. Date: Feb. 18, 2021

(54) System, Method, and Apparatus for Blocking False Alerts

(71) Applicant: PC Matic Inc, SIOUX CITY, IA (US)

(72) Inventors: Robert J. Cheng, Myrtle Beach, SC (US); Matthew Quincy Riley, Owosso, MI (US)

(73) Assignee: PC Matic Inc, SIOUX CITY, IA (US)

(21) Appl. No.: 16/541,390

(22) Filed: Aug. 15, 2019

(51) Int. Cl. G06F 21/55; G06F 21/62; G06F 21/56

(52) U.S. Cl. CPC G06F 21/554; G06F 21/6263; G06F 2221/2119; G06F 21/563; G06F 21/566

(57) ABSTRACT

A system for computer security includes a device protected by the system for computer security having software running on the device that detects an attempt to run a script in a browser. Responsive to the attempt to run the script in the browser or a pattern of function calls made by the script, the software running on the device scans the script and/or monitors the function calls to determine if the script is an infinite alert. If the script is an infinite alert, the software running on the device prevents execution of the script or kills the script if it is already running. If the script is not an infinite alert, the software running on the device allows execution/completion of the script. Determining if the script includes an infinite alert includes, for example, a certain length of script or finding certain 800 numbers and/or specific keywords in the script.

### FIELD

This invention relates to the field of computer infections and more particularly to a system for blocking false alerts.

### BACKGROUND

Currently, many computer systems provide a vast amount of useful information and access through browsers. As one navigates through the Internet, users often find themselves typing in or copying web addresses and, sometimes, missing a character, transposing a few characters, or mistyping. Further, some search engines and blogs include links to less than reputable advertisements.

Unfortunately, there are many undesirable results from visiting a website that is one letter different from the website you wish to visit. One result is navigating to a website that may not meet your tastes or moral stance. For example, trying to navigate to the whitehouse and entering whitehouse.com instead of whitehouse.gov may land you at somebody's website that contains undesirable content.

Some people/companies purposely prey on those that mistype or miscopy a website address, for example, by occupying a range of website addresses that have similar web addresses (URLs) to a popular website. It is easy for a user to enter a ‘1’ (one) instead of an ‘I’ (capital i) or a ‘0’ (zero) instead of an ‘O’ (capital o). It is also common for a user to enter the wrong suffix in a web address. For example, to visit a college website, instead of entering “college.edu,” the user enters “college.com.”

Further, sketchy advertising networks are very common along with hacked websites, all of which will take the unsuspecting user to an undesirable website.

So, what happens when an unsuspecting user navigates to one of these websites? Some such websites are laced with viruses, but with modern virus protection software, this is not as big of an issue and these viruses are usually blocked or defeated. Some such websites have legitimate businesses and hope that when the unsuspecting user navigates to such websites, that user will buy something or pay money.

The present application is more concerned with one type of malicious website that presents a pop-up message, usually saying that your computer is infected with a virus, often entering full-screen mode and emitting loud sounds and/or audio messages. The text and/or audio message includes a phone number for the user to call, and an unsuspecting user that calls that number will be in for a surprise. Often, when these numbers are called, the unsuspecting user will do what the person at the other end of the line requests, usually without hesitation. Often the person at the other end of the line requests that the user navigate to a different website that will allow the person at the other end of the line to freely access any resources on the “infected” computer or allowing installation of other virus software, etc.

The malicious websites often force the user's browser into full screen mode so that the user loses control of their computer (not being able to minimize the browser with the virus alert message). Further, many operating systems try to reload programs that are running after a reboot, so even if the user reboots their computer, once it initializes, the same browser starts in full screen mode, trapping the user's computer.

A user calling such number might be enticed to send money, gift cards, or provide vital information such as login credentials, etc. Often money is requested for services that the user does not need or may already have. Many unsuspecting users call these phone numbers and provide tax identification numbers (e.g. social security numbers), passwords, credit card numbers, personal information, etc.

What is needed is a system that will block these malicious and annoying warning messages from unscrupulous websites.

### SUMMARY

In a computer-based system, a system for computer security includes a device protected by the system for computer security having software running on the device that detects an attempt to run a script in a browser. Responsive to the attempt to run the script in the browser or function calls made by the script, the software running on the device scans the script and/or monitors function calls to determine if the script is an infinite alert and if the script is an infinite alert, the software running on the device prevents execution of the script or kills the script if it is already running. If the script is not an infinite alert, the software running on the device allows execution/completion of the script.

In one embodiment, a method of protecting a computer is disclosed including intercepting a request to run a script in a browser running on the computer then determining if the script includes an infinite alert. If the script includes an infinite alert, the script is prevented from running; otherwise the script is allowed to run in the browser but function calls from the script are monitored and if the script behaves suspiciously (e.g. attempts to enter full-screen mode, increases the system volume level, etc.) the running script is killed, stopped, or terminated.

In another embodiment, program instructions tangibly embodied in a non-transitory storage medium for provide security to a computer-based device. The program instructions include computer readable instructions running on the computer-based device that intercept a request to run a script in a browser running on the computer-based device. The computer readable instructions running on the computer-based device determine if the script includes an infinite alert and if the script includes an infinite alert, the computer readable instructions running on the computer-based device prevent the script from running; otherwise the script is allowed to run in the browser.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data connection diagram of the computer security system.

FIG. 2 illustrates a schematic view of a typical user device protected by the computer security system.

FIG. 3 illustrates a simplified browser user interface of the typical user device protected by the computer security system.

FIG. 4 illustrates a simplified browser user interface of the typical user device protected by the computer security system.

FIG. 5 illustrates a simplified web page example of the computer security system.

FIG. 6 illustrates a simplified browser user interface of the typical user device protected by the computer security system.

FIG. 7A illustrates a first example of an infinite alert.

FIG. 7B illustrates a second example of an infinite alert.

FIG. 8 illustrates a warning message regarding an infinite alert.

FIGS. 9, 10, and 11 illustrate program flows of the computer security system.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

In general, the computer security system provides a level of protection from an unsuspecting user being alerted to the detection of a non-existing virus by a script, herein called an “infinite alert.”

Throughout this description, the term, “user device” refers to any system that has a processor and runs software, and is capable of initiating any type of phone call. One example of such is a personal computer. Another example is a smartphone or tablet. The term, “user” refers to a human that has an interest in the computer, perhaps a user who is using the computer.

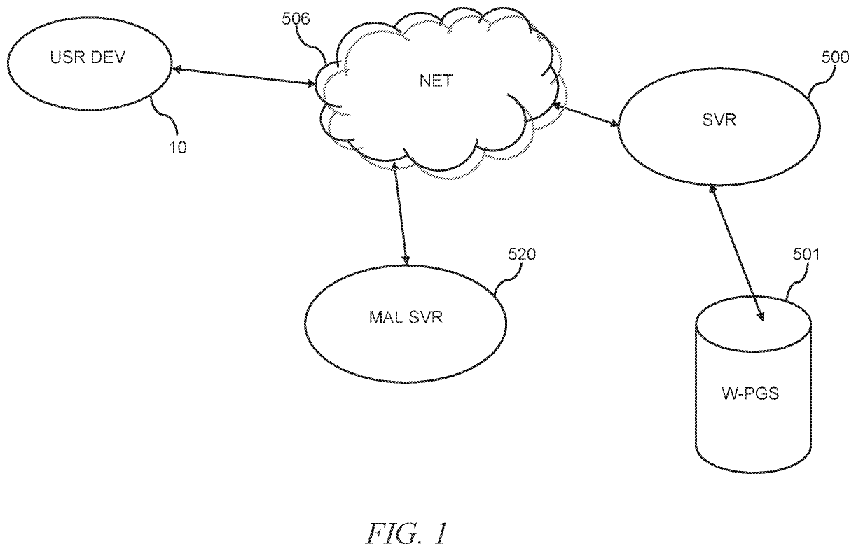

Referring to FIG. 1, a data connection diagram of the exemplary computer security system is shown. In this example, a user device 10 (e.g., personal computer, smartphone) communicates using a browser (as known in the industry) through a network 506 (e.g. the Internet, local area network, etc.) to a server computer 500 (e.g. website) that hosts a web page to which the user is browsing. The server computer 500 has access to data storage 501 as an example, for containing data and web pages.

The server computer 500 transacts with software running on the user device 10 through the network(s) 506.

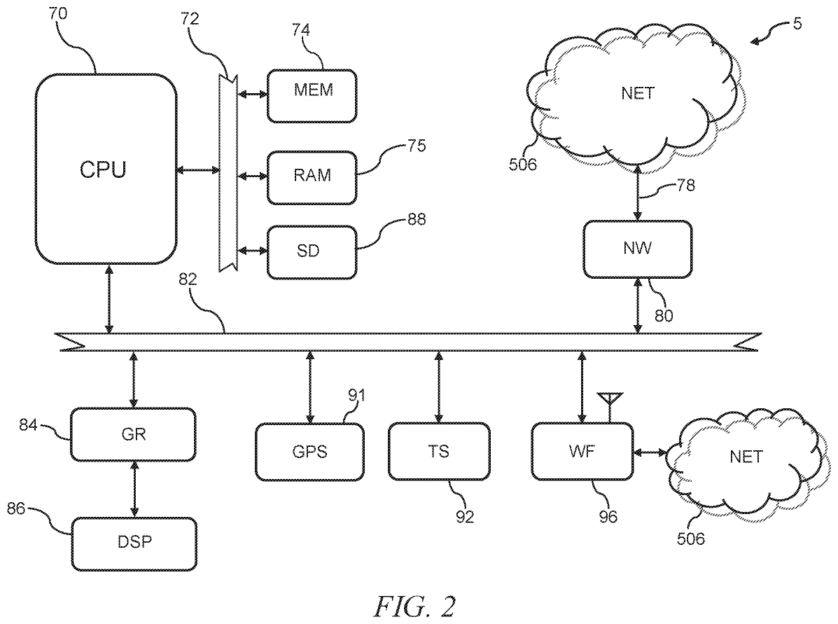

Referring to FIG. 2, a schematic view of a typical computer 5 used as an example of a user device 10 or server computer 500 is shown. The present invention is in no way limited to any particular typical computer 5 systems. Many typical computers 5 that are processor-based devices are anticipated including, but not limited to smartphones, cellular phones, portable digital assistants, personal computers, smart watches, cordless phones, etc.

The example typical computer system 5 is shown to represent a typical user device 10 that is protected by the computer security system. This exemplary user device 10 is shown in its simplest form.

Different architectures are known that accomplish similar results in a similar fashion, and the present invention is not limited in any way to any particular user device 10 system architecture or implementation. In this exemplary user device 10, a processor 70 executes or runs programs in a random-access memory 75. The programs are generally stored within a persistent memory 74 and loaded into the random-access memory 75 when needed. In some user devices 10, a removable storage 88 (e.g., compact flash, SD) offers removable persistent storage. The processor 70 is any processor, typically a processor designed for phones. The persistent memory 74, random-access memory 75, and SIM card are connected to the processor by, for example, a memory bus 72. The random-access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, etc. In some exemplary user device 10, the persistent memory 74 is removable, in the form of a memory card of appropriate format such as SD (secure digital) cards, micro SD cards, compact flash, etc.

Also connected to the processor 70 is a system bus 82 for connecting to peripheral subsystems such as a network interface 80, a graphics adapter 84 and a touch screen interface 92. The graphics adapter 84 receives commands from the processor 70 and controls what is depicted on the display 86. The touch screen interface 92 provides navigation and selection features.

In general, some portion of the persistent memory 74 and/or the removable storage 88 is used to store programs, executable code, phone numbers, contacts, and data, etc. In some embodiments, other data is stored in the persistent memory 74 such as audio files, video files, text messages, etc.

The peripherals are examples, and other devices are known in the industry such as Global Positioning Subsystems, speakers, microphones, USB interfaces, cameras, microphones, Bluetooth transceivers, Wi-Fi transceiver 96, image sensors, temperature sensors, etc., the details of which are not shown for brevity and clarity reasons.

The network interface 80 connects the user device 10 to the network 506 (e.g. Internet) through any known or future protocol such as Ethernet (IEEE 802.3), etc. There is no limitation on the type of connection used. The network interface 80 provides data connections between the user device 10 and the server computer 500 through any network 506. In some embodiments, the Wi-Fi transceiver 96 is used to connect to the network 506.

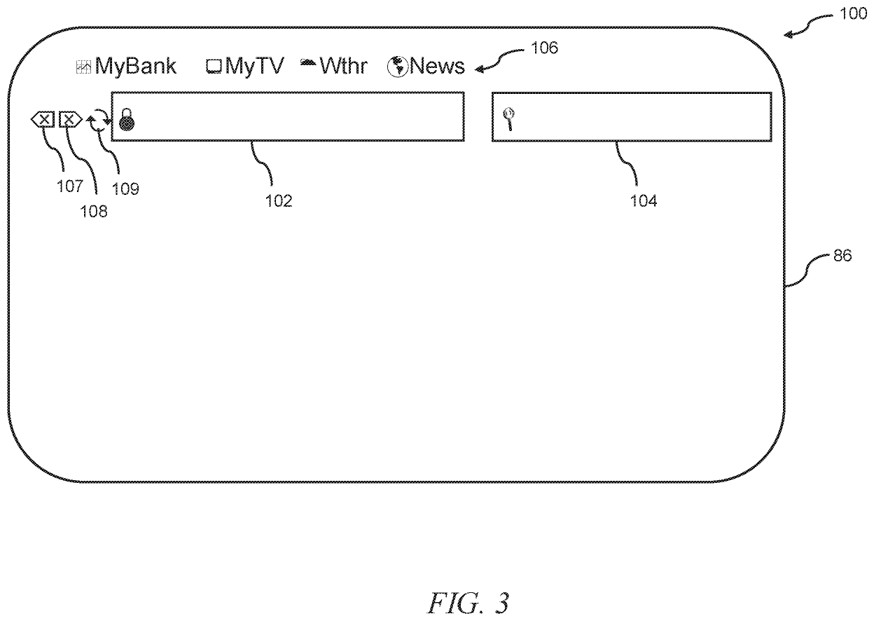

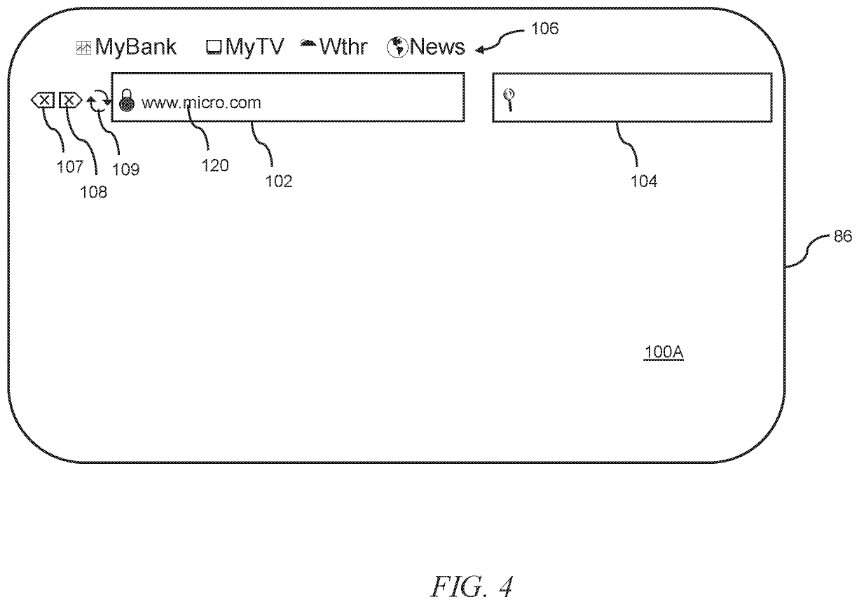

Referring to FIGS. 3 and 4, a simplified browser user interface 100 of the typical user device 10 protected by the computer security system is shown. In both figures, the simplified browser user interface 100 shown has several pre-stored links 106 to frequently browsed websites, a back navigation button 107, a forward navigation button 108, and a refresh button 109. As with many such browser user interfaces, there is a place to enter a web address 102 (e.g. a Unified Resource Locator or URL) or a search term 104.

In the simplified browser user interface 100A of FIG. 4, a user has entered a web address 120 into the place to enter a web address 102 so that the user can visit the web page at www.micro.com.

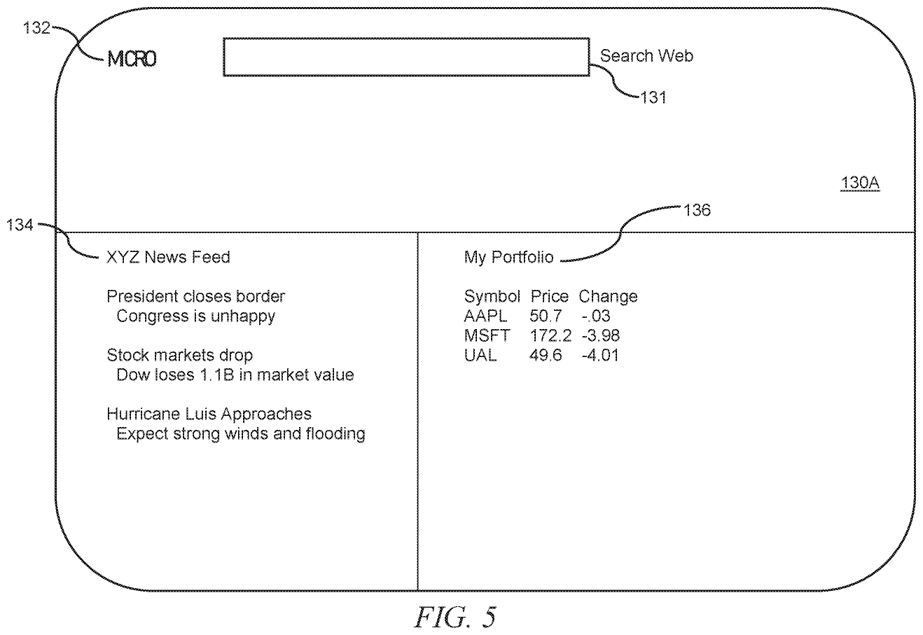

Referring to FIG. 5, a simplified web page example 130A of the computer security system is shown. This is an example of what the user has found at the web address “micro.com”. As an example, this simplified web page example 130A has a title 132, a place to enter a search term 131, some news links 134 and some stock market information 136. The content of this simplified web page example 130A is not important, only the fact that the user correctly typed the web address 120 and reached the correct simplified web page example 130A.

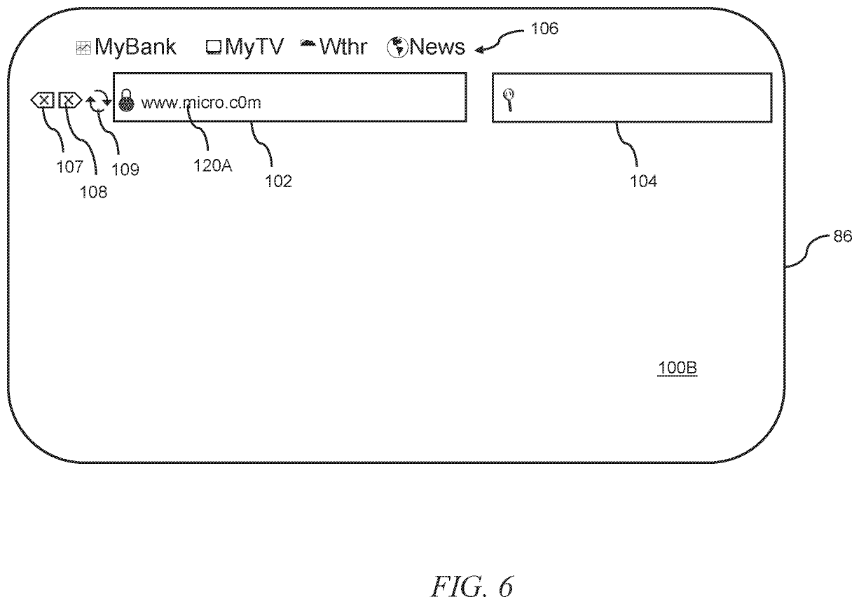

Referring to FIG. 6, another simplified browser user interface 100B of the typical user device 10 protected by the computer security system is shown. As with FIGS. 3 and 4, the simplified browser user interface 100B shown has several pre-stored links 106 to frequently browsed websites, a back navigation button 107, a forward navigation button 108, and a refresh button 109. As with many such browser user interfaces 100, there is a place to enter a web address 102 (e.g. a Unified Resource Locator or URL) or a search term 104.

In this case, the user has entered a web address 120 into the place to enter a web address 102 so that the user can visit the web page at “www.micro.com”, but has mistyped “www.micro.com”. Instead of a ‘o’, the user has typed a zero (‘0’) as in www.micro.c0m. This is a common mistake.

Knowing that users often mistype common web addresses, many companies occupy the web addresses that are similar to the common web addresses. For example, one might occupy g00gle.com, whitehouse.com (instead of whitehouse.gov), irs.com (instead of irs.gov or treasury.gov), etc. Some of these companies do provide services, as one might imagine, a company that prepares tax returns might be interested in those visiting “irs.com.” On the other hand, some of these companies are not legitimate operations or, in the least, not companies that the user will want to work with or pay money to.

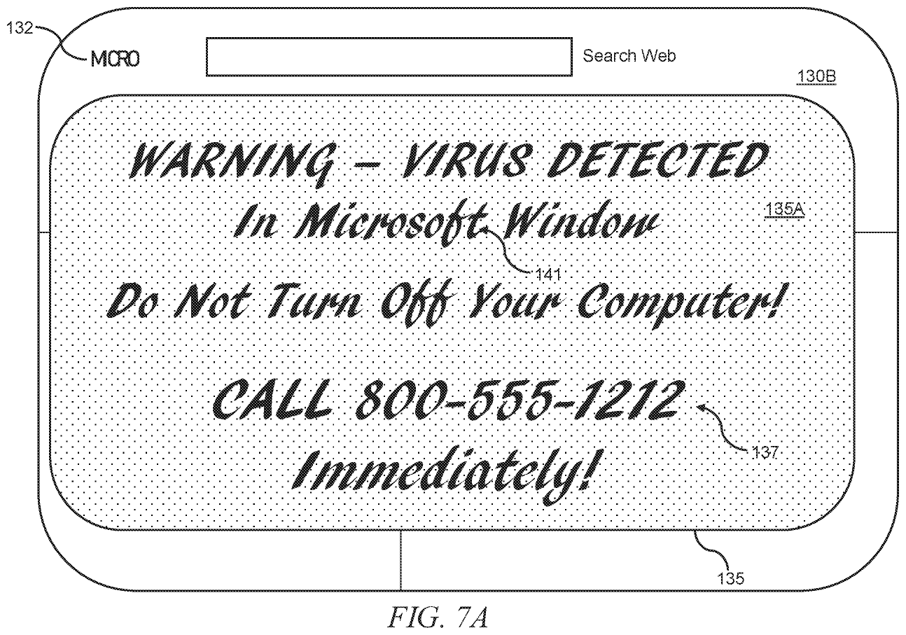

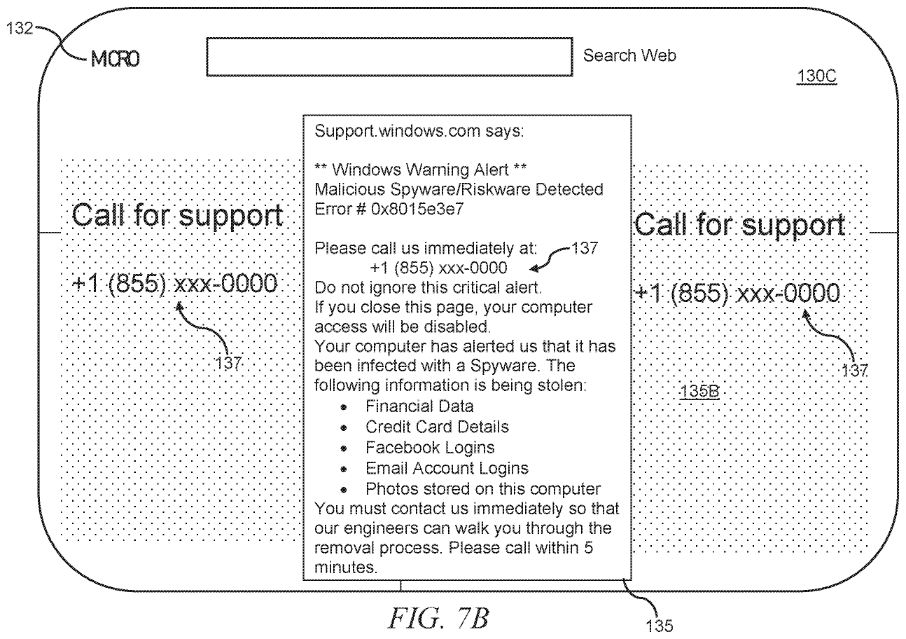

Referring to FIG. 7A, a first example of an infinite alert 135A is shown. This infinite alert 135A includes a strongly worded warning message 135 that includes a company name 141 that helps make the strongly worded warning message 135 appear legitimate and usually includes a phone number 137 to which this company hopes the user will call. In some infinite alert warnings, an alert is made telling the user that they have performance issues or any other issue.

Upon calling the phone number, an operator at the other end will request information from the user. Some such companies are only looking to charge the user a fee for removing the virus, but providing a credit card, expiration date, and security code to these companies is a dangerous thing. Some companies do much worse. For example, once the trust of the user is gained, the operator will request the user navigate to the company's web site and execute one or more commands which will allow the operator full control and access to the user device 10. This allows the operator to install various malware programs, relax security of the user device 10, and even extract files that the company can later use to thwart security, access sensitive data, etc. Nothing good comes of calling this phone number 134.

Referring to FIG. 7B, a second example of an infinite alert 135B is shown. This infinite alert 135B includes a strongly worded warning message 135 that is made realistic to help make the strongly worded warning message 135 appear legitimate. The strongly worded warning message 135 includes a phone number 137 to which this company hopes the user will call.

As with FIG. 7A, upon calling the phone number, an operator at the other end will request information from the user. Some such companies are only looking to charge the user a fee for removing the virus, but providing a credit card, expiration date, and security code to these companies is a dangerous thing. Some companies do much worse. For example, once the trust of the user is gained, the operator will request the user navigate to the company's web site and execute one or more commands which will allow the operator full control and access to the user device 10. This allows the operator to install various malware programs, relax security of the user device 10, and even extract files that the company can later use to thwart security, access sensitive data, etc. Nothing good comes of calling this phone number 134.

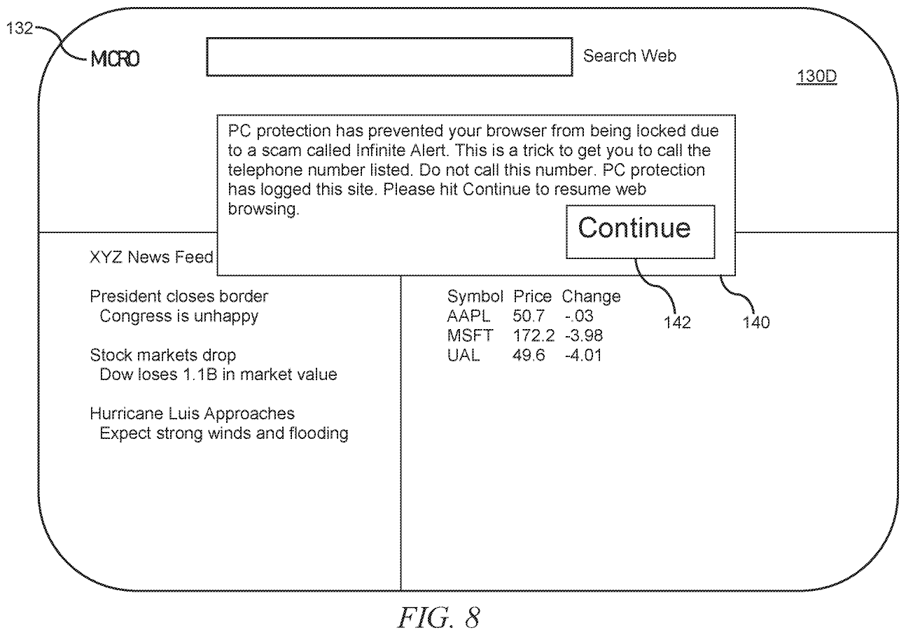

Referring to FIG. 8, an informational message 140 regarding an infinite alert is shown. In this, the computer security system has detected an attempt to issue an infinite alert 135A/135B and has prevented the infinite alert 135A/135B from executing. Instead, the informational message 140 is displayed as the user might wonder why their browser user interface 100 has not navigated to the web address desired. A “continue” or “ok” function 142 is present so that the user, selecting the “continue” or “ok” function 142, is able to correct their mistyped web address and continue browsing.

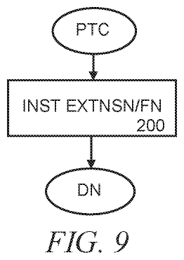

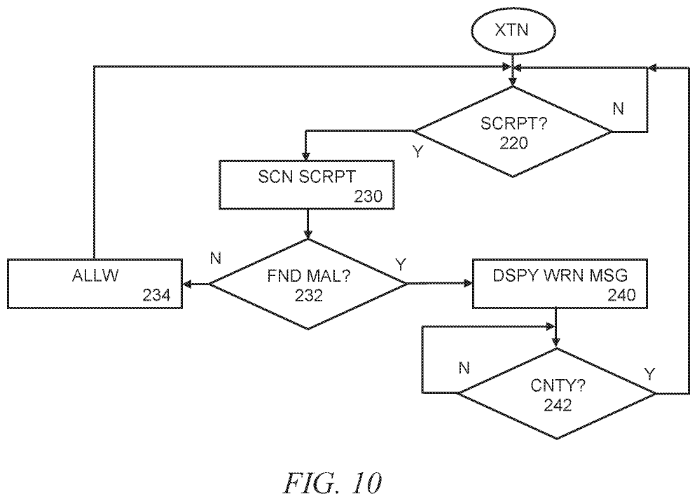

Referring to FIGS. 9, 10, and 11, exemplary program flows of the computer security system are shown. In the embodiments shown, program flow begins with installation 200 of the disclosed computer security system. Installation 200 includes installing of a plugin or extension into the browser or browsers of the user device 10 (some user devices 10 have multiple browsers). This installation is performed either manually or included when a suite of computer security programs are installed.

In FIG. 9, an example of the computer security programs that is installed as a plugin or extension into the browser is shown. This program runs when the browser starts and looks for any attempt to execute a script (e.g. JavaScript, as known in the industry), in particular any attempt to execute an alert window script such as a Javascript alert window script. The infinite alerts 135A/135B usually use JavaScripts to display their strongly worded warning message 135 and/or emit audio or noise, etc. In cases where the plugin allows a script to run, further checking is performed by installing browser function intercepts/replacements that monitor calls made by the script to perform such functions as enter full-screen mode, display alert functions, and/or increase system volume and emit audio messages, etc.

As shown in FIG, 10, the computer security program watches activity of the browser looking for an execution attempt 220 of a script (e.g. a JavaScript). Once an execution attempt 220 of a script is detected, the script is scanned 230 looking for an infinite alert 135A/135B by looking for indications that the script is an infinite alert. The script is scanned heuristically for content, length, number of times for pop-ups, etc. Examples of content typically found in infinite alerts are phone numbers or toll-free numbers (800, 844, 888, 855, 866, etc.) as well as specific indicator words such as “Support,” “Microsoft,” “Tech Support,” etc. In general, as infinite alert scripts are found, the length of such scripts is recorded so that, as scripts of equal length are found when the script is scanned 230, those scripts are not allowed to run. In general, legitimate scripts that issue alerts generally have rather short lengths with short messages such as “task completed.” Note that as infinite alert scripts evolve, likewise the heuristics are updated to detect and block new infinite alert scripts. For example, new infinite alerts often have different phone numbers or spelling derivations from prior infinite alerts (e.g. “Teck Support” instead of “Tech Support”). In such, the heuristic that performs the scan 230 is often updated to include new heuristics that detect new infinite alert scripts.

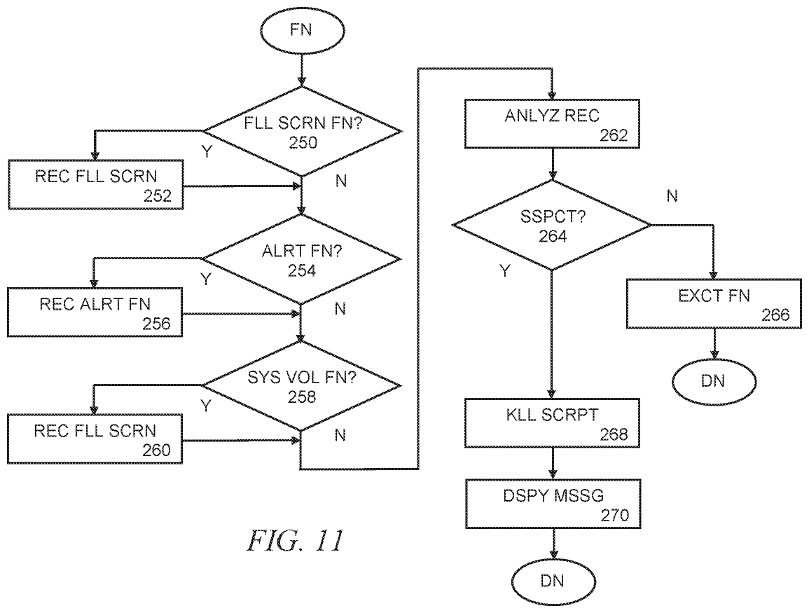

If the scan 230 does not find 232 any indication of an infinite alert, the script is allowed to run 234 and the above repeats. Note that, in some embodiments, even after the script is allowed to run 234, calls to certain browser functions are monitored to watch for activities indicative of an infinite alert script, as described below with FIG. 11.

If the scan 230 finds 232 any indication of an infinite alert, a warning messages is displayed 240 and the computer security program waits 242 until the continue icon is selected (indicating that the user knows what happened), at which time the above is repeated. The warning message is displayed 240 for several reasons including to make the user aware that they may have mistyped a web address (e.g. URL), and to provide an indication to the user as to why they could not visit the requested web address.

As shown in FIG. 11, the computer security program intercepts function calls made by the script. In this example, three types of function calls are monitored, though any number of different function call monitoring is anticipated. If a function call to enter full-screen mode 250 is made, it is recorded that the current script is making an attempt to enter full screen mode 252. If a function call to make an alert 254 is made, it is recorded that the current script is making an attempt to make an alert 256. If a function call to increase the system volume 258 is made, it is recorded that the current script is making an attempt to increase the system volume 260. Now, the accumulation of function calls made by the script is analyzed 262 to determine if the script is suspicious. If the script is not suspicious 264, the requested function is executed/allowed 266 (e.g., full-screen mode is allowed, system volume increase is allowed, alert function is allowed, etc.). If the script is suspicious 264, the security program kills the script 268 and, optionally, displays a message 270 regarding what happened.

As users report infinite alerts, heuristics are updated to include newly found infinite alerts and the heuristics are pushed to all users to prevent infection by these new infinite alerts.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for computer security of a computer-based device, the system comprising:
a device protected by the system for computer security;
software running on the device detects an attempt to run a script in a browser and responsive to the attempt to run the script in the browser, the software running on the device scans the script to determine if the script contains an infinite alert and if the script contains the infinite alert, the software running on the device prevents execution of the script;
if the script does not contains the infinite alert, the software running on the device allows execution of the script; and
while the script runs, the software running on the device monitors calls to one or more browser functions and analyzes calls made to the one or more browser functions and if the calls made to the one or more browser functions indicate that the scrip contains the infinite alert, the software running on the device kills the script.

2. The system of claim 1, wherein the software running on the device scans the script to determine if the script contains the infinite alert by looking for toll free numbers in the script.

3. The system of claim 1, wherein the software running on the device scans the script to determine if the script contains the infinite alert by looking for specific keywords in the script.

4. The system of claim 3, wherein the specific keywords are one or more keywords from the group consisting of “Support,” “Microsoft,” and “Tech Support.”

5. The system of claim 1, wherein the script is a javascript.

6. The system of claim 1, wherein after the software running on the device prevents the execution of the script, the software running on the device presents a message and waits for an acknowledgment of the message.

7. The system of claim 1, wherein the one or more browser functions comprises a function to issue an alert, a function to enter full-screen mode, and a function to increase a system volume level.

8. A method of protecting a computer, the method comprising:
intercepting a request to run a script in a browser running on the computer;
determining if the script contains an infinite alert; and
if the script contains the infinite alert, preventing the script from running, otherwise allowing running of the script in the browser.

9. The method of claim 8, wherein the step of determining comprises scanning the script for toll free numbers in the script and determining that the script contains the infinite alert if finding any of the toll free numbers in the script.

10. The method of claim 8, wherein the step of determining comprises scanning the script for specific keywords in the script and determining that the script contains the infinite alert if finding any of the specific keywords in the script.

11. The method of claim 10, wherein the specific keywords are one or more keywords from the group consisting of “Support,” “Microsoft,” and “Tech Support.”

12. The method of claim 8, wherein the script is a javascript.

13. The method of claim 8, further comprising after the step of allowing running of the script in the browser, a step of monitoring calls to one or more browser functions and analyzing the calls made to the one or more browser functions and if the analyzing indicates that the scrip contains the infinite alert, killing the script.

14. The method of claim 13, wherein the one or more browser functions comprises a function to issue an alert, a function to enter full-screen mode, and a function to increase a system volume level.

15. Program instructions tangibly embodied in a non-transitory storage medium for providing security to a computer-based device, wherein the at least one instruction comprises:
computer readable instructions running on the computer-based device intercepting a request to run a script in a browser running on the computer-based device;
the computer readable instructions running on the computer-based device determining if the script includes an infinite alert; and
if the script includes the infinite alert, the computer readable instructions running on the computer-based device preventing the script from running, otherwise the computer readable instructions running on the computer-based device allowing running of the script in the browser.

16. The program instructions tangibly embodied in the non-transitory storage medium of claim 15, wherein the computer readable instructions running on the computer-based device for determining comprises computer readable instructions running on the computer-based device scanning the script for toll free numbers in the script and computer readable instructions running on the computer-based device determining that the script contains the infinite alert if finding any of the toll free numbers in the script.

17. The program instructions tangibly embodied in the non-transitory storage medium of claim 15, wherein the computer readable instructions running on the computer-based device for determining comprises computer readable instructions running on the computer-based device scanning the script for specific keywords in the script and computer readable instructions running on the computer-based device determining that the script contains the infinite alert if finding any of the specific keywords in the script.

18. The program instructions tangibly embodied in the non-transitory storage medium of claim 17, wherein the specific keywords are one or more keywords from the group consisting of “Support,” “Microsoft,” and “Tech Support.”

19. The program instructions tangibly embodied in the non-transitory storage medium of claim 15, further comprising after allowing running of the script in the browser, the computer readable instructions running on the computer-based device monitoring calls to one or more browser functions and the computer readable instructions running on the computer-based device analyzing the calls made to the one or more browser functions and if the analyzing indicates that the scrip contains the infinite alert, the computer readable instructions running on the computer-based device killing the script.

20. The program instructions tangibly embodied in the non-transitory storage medium of claim 19, wherein the one or more browser functions comprises a function to issue an alert, a function to enter full-screen mode, and a function to increase a system volume level.
